(19) United States
(12) Patent Application Publication
(10) Pub. No.: US 2021/0142919 A1
(43) Pub. Date: May 13, 2021

(54) SECONDARY SHUTDOWN SYSTEM OF NUCLEAR REACTOR USING MELTING SEAL

(71) Applicant: KEPCO ENGINEERING & CONSTRUCTION COMPANY, INC., Gimcheon-si (KR)

(72) Inventors: Gee Seok KIM, Seo-gu (KR); Chang Kyu CHUNG, Sejong-si (KR); Jong Tae SEO, Yuseong-gu (KR); Byung Jin LEE, Yuseong-gu (KR); Jin Seok PARK, Sejong-si (KR)

(21) Appl. No.: 17/086,806

(22) Filed: Nov. 2, 2020

(30) Foreign Application Priority Data
Nov. 11, 2019 (KR) 10-2019-0143745

(51) Int. Cl. G21C 9/033; G21C 9/027

(52) U.S. Cl. CPC G21C 9/033; G21C 9/027

(57) ABSTRACT

A secondary shutdown system for a nuclear reactor using melting seal includes a guide pipe located inside the nuclear reactor, a storage container communicating with the guide pipe and storing a neutron absorber therein, a sealing member provided in the storage container and configured to close an outlet of the storage container so that the neutron absorber stored in the storage container is not moved, and a hot wire configured to supply heat to the sealing member, wherein the sealing member is melted by the heat supplied by the hot wire to open the storage container and move the neutron absorber to the guide pipe.

### CROSS-REFERENCE TO RELATED APPLICATION

This application is based on and claims priority under 35 U.S.C. § 119 to Korean Patent Application No. 10-2019-0143745, filed on Nov. 11, 2019, in the Korean Intellectual Property Office, the disclosure of which is incorporated by reference herein in its entirety.

### BACKGROUND

### 1. Field

One or more embodiments relate to a secondary shutdown system of a nuclear reactor using melting seal, and more particularly, to a secondary shutdown system of a nuclear reactor using melting seal, wherein the secondary shutdown system may contain a neutron absorber through a meltable sealing member and a storage container provided over a guide pipe and may inject the neutron absorber into the guide pipe by melting the sealing member when a nuclear reactor accident occurs.

### 2. Description of Related Art

According to general reactor design criteria, it is necessary that two independent reactivity control systems of different design principles be provided. In general, a pressurized light water reactor uses control rods as a primary reactivity control system, and uses a method of injecting boric acid water into a moderator as a secondary reactivity control system.

However, the method of using the boric acid water as the secondary reactivity control system has the following problems. When the boric acid water is used, there is a possibility of corrosion of a reactor coolant system due to boric acid and corrosion and damage of a pressure boundary due to boric acid leakage. Also, a considerably large additional space is required according to the complex boric acid injection and recovery equipment of a chemical and volume control system (CVCS). Therefore, use of a boric acid-free operation without using boric acid has arisen, and in order for a boric acid-free operation to be performed, a new secondary reactivity control system for replacing boric acid is required.

Also, a conventional secondary reactivity control system is operated through artificial manipulation during both a normal operation or in the event of an accident. However, in a situation where an accident occurs, power is lost, and a nuclear reactor must be stopped quickly, if the control system becomes inoperable due to an operator's judgment error, a serious accident may occur.

### SUMMARY

One or more embodiments include a passive secondary shutdown system of a nuclear reactor using melting seal, wherein the passive secondary shutdown system may contain a neutron absorber through a meltable sealing member and a storage container provided over a guide pipe and may inject the neutron absorber into the guide pipe by melting the sealing member when a nuclear reactor accident occurs.

Additional aspects will be set forth in part in the description which follows and, in part, will be apparent from the description, or may be learned by practice of the presented embodiments.

According to one or more embodiments, a secondary shutdown system for a nuclear reactor using melting seal includes a guide pipe located inside the nuclear reactor, a storage container communicating with the guide pipe and storing a neutron absorber therein, a sealing member provided in the storage container and configured to close an outlet of the storage container so that the neutron absorber stored in the storage container is not moved, and a hot wire configured to supply heat to the sealing member, wherein the sealing member is melted by the heat supplied by the hot wire to open the storage container and move the neutron absorber to the guide pipe.

The hot wire may surround an outer surface of the storage container in which the sealing member is located.

The secondary shutdown system may further include a hot wire winding cylinder surrounding the hot wire outside the storage container.

The storage container may be located over the guide pipe and may communicate with the guide pipe, wherein the neutron absorber is moved to the guide pipe due to gravity when the sealing member is melted and the storage container is opened.

The sealing member may include a material that is melted when a temperature in the nuclear reactor rises to a designated temperature or more, wherein the sealing member is melted when the temperature in the nuclear reactor rises to the designated temperature or more, to open the storage container and move the neutron absorber to the guide pipe.

One or more neutron absorbers having a ball or rod shape are stored in the storage container, wherein the one or more neutron absorbers are connected to one another through a recovery line.

A recovery line ring having a loop or hook shape may be formed on a side of the recovery line.

The storage container may include a body portion and a lid portion detachably coupled to the body portion, wherein a coupling portion to which the recovery line ring is coupled is provided inside the lid portion.

An elastic body may be provided on a side of the storage container, wherein the elastic body is pressed by the neutron absorber, when the outlet of the storage container is closed by the sealing member.

The hot wire may pass through a side of a container of the nuclear reactor and may extend into the nuclear reactor, wherein a heat hot sealing portion for maintaining a pressure boundary inside the nuclear reactor is provided at the side of the container through which the hot wire passes.

The storage container and the guide pipe may be integrally formed with each other.

According to one or more embodiments, a secondary shutdown system for shutting down a nuclear reactor includes a guide pipe located inside the nuclear reactor, a storage container communicating with the guide pipe and storing a support rod therein, a sealing member provided in the storage container and configured to close an outlet of the storage container so that the support rod stored in the storage container is not moved, a hot wire configured to supply heat to the sealing member, and a neutron absorber connected to the support rod and located between the guide pipe and the sealing member, wherein the sealing member is melted by the heat supplied by the hot wire to open the storage container, move the support rod, and move the neutron absorber to the guide pipe.

An elastic body may be provided on a side of the storage container, wherein the elastic body is pressed by the support rod, when the outlet of the storage container is closed by the sealing member.

The storage container and the guide pipe may be integrally formed with each other.

### BRIEF DESCRIPTION OF THE DRAWINGS

The above and other aspects, features, and advantages of certain embodiments will be more apparent from the following description taken in conjunction with the accompanying drawings, in which:

FIG. 1 is a view of a secondary shutdown system of a nuclear reactor using melting seal which ensures the injection of a neutron absorber according to an embodiment of the present disclosure;

FIG. 2 is a view illustrating that the neutron absorber is moved to a guide pipe while a sealing member is melted according to an embodiment of the present disclosure;

FIG. 3 is a view illustrating that a recovery line on which a recovery line ring is formed is coupled to a coupling portion of a storage container and a plurality of neutron absorbers each having a rod shape are connected through the recovery line according to an embodiment of the present disclosure;

FIG. 4 is a view illustrating that the recovery line on which the recovery line ring is formed is coupled to the coupling portion of the storage container and a plurality of neutron absorbers each having a ball shape are connected through the recovery line according to another embodiment of the present disclosure;

FIG. 5 is a view illustrating that the neutron absorber moved to the guide pipe is recovered through the recovery line according to an embodiment of the present disclosure;

FIG. 6 is a view illustrating that the storage container and the guide pipe in the secondary shutdown system of the nuclear reactor using melting seal are integrally formed according to an embodiment of the present disclosure;

FIG. 7 is a view illustrating a secondary shutdown system of a nuclear reactor using melting seal which ensures the injection of a support rod when a nuclear reactor is overturned according to another embodiment of the present disclosure;

FIG. 8 is a view illustrating that the sealing member is melted to move the support rod and move the neutron absorber moves to the guide pipe according to another embodiment of the present disclosure;

FIG. 9 is a view illustrating that the recovery line on which the recovery line ring is formed is coupled to the coupling portion of the storage container and the support rod and the neutron absorber each having a rod shape are connected through the recovery line according to another embodiment of the present disclosure;

FIG. 10 is a view illustrating that the neutron absorber and the support rod moved into the guide pipe are recovered through the recovery line according to another embodiment of the present disclosure;

FIG. 11 is a view illustrating that the storage container and the guide pipe in the secondary shutdown system of the nuclear reactor using melting seal are integrally formed according to another embodiment of the present disclosure; and

FIG. 12 is a view illustrating that the neutron absorber includes the support rod according to another embodiment of the present disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Principles and embodiments of the present disclosure will be described in detail in order to fully convey the scope of the present disclosure and enable one of ordinary skill in the art to embody and practice the present disclosure. The embodiments may be implemented in various forms.

As used in various embodiments of the present disclosure, the expressions “include,” “may include” and other conjugates refer to the existence of a corresponding disclosed function, operation, or constituent element, and do not limit one or more additional functions, operations, or constituent elements. Further, as used in various embodiments of the present disclosure, the terms “include,” “have” and their conjugates may be construed to denote a certain feature, number, step, operation, constituent element, component or a combination thereof, but may not be construed to exclude the existence of or a possibility of addition of one or more other features, numbers, steps, operations, constituent elements, components or combinations thereof.

When a component is referred to as being “connected” or “coupled” to any other component, it should be understood that the component may be directly connected or coupled to the other component, but another new component may also be interposed between them. In contrast, when a component is referred to as being “directly connected” or “directly coupled” to any other component, it should be understood that there is no new component between the component and the other component.

The present disclosure relates to a secondary shutdown system of a nuclear reactor using melting seal, and more particularly, to a secondary shutdown system of a nuclear reactor using melting seal, which may contain a neutron absorber through a meltable sealing member and a storage container provided over a guide pipe and may inject the neutron absorber into the guide pipe by melting the sealing member when a nuclear reactor accident occurs.

Reactivity control of a nuclear reactor is basically implemented by a control rod assembly driven by a control rod driving device that is a primary shutdown system. However, according to atomic energy licensing requirements and nuclear reactor safety regulations, a secondary shutdown system of a nuclear reactor which may operate independently of the primary shutdown system is required.

While a secondary shutdown system is implemented by using a boric acid water injection method in the related art, a secondary shutdown system of a nuclear reactor using melting seal according to an embodiment of the present disclosure uses a method of inserting a neutron absorber 130 into a guide pipe 110 provided in a nuclear fuel assembly 111 in order to shut down a nuclear reactor when a nuclear reactor accident occurs. The secondary shutdown system of the nuclear reactor using melting seal according to an embodiment of the present disclosure may shut down the nuclear reactor by inserting the neutron absorber 130 into the nuclear fuel assembly 111 through the guide pipe 110. Hereinafter, embodiments of the present disclosure will be described in detail with reference to the accompanying drawings.

Referring to FIG. 1, the secondary shutdown system of the nuclear reactor using melting seal according to an embodiment of the present disclosure includes the guide pipe 110, a storage container 120, a sealing member 140, and a hot wire 150.

The guide pipe 110 may be located inside a nuclear reactor 10 and may be provided in the nuclear fuel assembly 111. When the neutron absorber 130 is inserted into the guide pipe 110, the nuclear reactor 10 may be shut down in the event of a nuclear reactor accident.

The storage container 120 communicates with the guide pipe 110 and stores the neutron absorber 130 therein. It is preferable that the storage container 120 communicating with the guide pipe 110 is located over the guide pipe 110. Once the storage container 120 is located over the guide pipe 110, the neutron absorber 130 may move to the guide pipe 110 due to gravity when the sealing member 140 is melted and the storage container 120 is opened.

The storage container 120 may have a tubular shape, but the present disclosure is not limited thereto. The storage container 120 may have any of various shapes as long as the storage container 120 may communicate with the guide pipe 110 to move the neutron absorber 130 to the guide pipe 110.

The sealing member 140 may be provided in the storage container 120 and may be configured to close an outlet 125 of the storage container 120 so that the neutron absorber 130 stored in the storage container 120 is not moved.

The sealing member 140 may block the outlet 125 through which the storage container 120 and the guide pipe 110 communicate with each other, so that the neutron absorber 130 stored in the storage container 120 is not moved and is contained.

The hot wire 150 may supply heat to the sealing member 140. The sealing member 140 may be formed of a material that may be melted by the heat supplied by the hot wire 150, and the sealing member 140 may be configured to open the storage container 120 by being melted by the heat supplied by the hot wire 150.

In detail, referring to FIG. 2, when the sealing member 140 is melted by the hot wire 150, a melted sealing member 141 is moved to the guide pipe 110 to open the outlet 125 of the storage container 120, and thus the neutron absorber 130 is moved to the guide pipe 110. In this case, because the storage container 120 is provided over the guide pipe 110, the neutron absorber 130 may be moved to the guide pipe 110 due to gravity. The neutron absorber 130 moved to the guide pipe 110 is inserted into the nuclear fuel assembly 111 to shut down the nuclear reactor 10.

A time when heat is supplied to the sealing member 140 through the hot wire 150 may be a time when a nuclear reactor accident occurs, and when a nuclear reactor accident is detected, heat may be supplied to the hot wire 150 through a power supply device. In detail, when the nuclear reactor 10 needs to be shut down, the sealing member 140 may be melted by a heat source of the hot wire 150 by applying current to the hot wire 150.

Any of various methods of supplying heat from the hot wire 150 to the sealing member 140 may be used. Although the hot wire 150 may be directly connected to the sealing member 140, it is preferable that, in order to easily insert and withdraw the storage container 120 storing the neutron absorber 130, the hot wire 150 surrounds an outer surface of the storage container 120.

In detail, referring to FIG. 1, it is preferable that the hot wire 150 surrounds an outer surface of the storage container 120 in which the sealing member 140 is located. Also, the secondary shutdown system of the nuclear reactor using melting seal according to an embodiment of the present disclosure may further include a hot wire winding cylinder 160 surrounding the hot wire 150 outside the storage container 120.

The hot wire winding cylinder 160 may surround the hot wire 150 that surrounds the outer surface of the storage container 120, and the hot wire 150 may be located between the hot wire winding cylinder 160 and the storage container 120.

When heat is supplied to the hot wire 150, temperatures of the hot wire winding cylinder 160 and the storage container 120 are increased due to the hot wire 150, and thus the sealing member 140 is melted and the outlet 125 of the storage container 120 is opened as shown in FIG. 2. Once the outlet 125 of the storage container 120 is opened, the neutron absorber 130 contained in the storage container 120 is inserted into the guide pipe 110 and the nuclear fuel assembly 111 to shut down the nuclear reactor 10.

Although the sealing member 140 is melted due to heat supplied by the hot wire 150, the present disclosure is not limited thereto. When a temperature in the nuclear reactor 10 rises to a certain temperature or more, the sealing member 140 may be naturally melted to open the outlet 125 of the storage container 120.

In detail, the sealing member 140 may be formed of a material that is melted when a temperature in the nuclear reactor 10 rises to a designated temperature or more. The designated temperature in the nuclear reactor 10 may be a temperature generated when a nuclear reactor accident occurs, and the sealing member 140 may be formed of any of various materials according to the designated temperature.

When a nuclear reactor accident occurs and a temperature in the nuclear reactor 10 rises to the designated temperature or more, the sealing member 140 is melted and the storage container 120 is opened so that the neutron absorber 130 moves to the guide pipe 110.

When a nuclear reactor accident occurs, a temperature in the nuclear reactor 10 inevitably rises. Because the secondary shutdown system of the nuclear reactor using melting seal according to an embodiment of the present disclosure melts the sealing member 140 by using the temperature in the nuclear reactor 10, the operational reliability of the secondary shutdown system of the nuclear reactor may be improved.

Referring to FIGS. 3 and 4, the neutron absorber 130 stored in the storage container 120 may have a ball or rod shape, and a plurality of neutron absorbers 130 may be contained in the storage container 120.

The plurality of neutron absorbers 130 may be connected through a recovery line 131. Once the plurality of neutron absorbers 130 are connected through the recovery line 131, the neutron absorbers 130 may be easily recovered after the neutron absorbers 130 are inserted into the guide pipe 110.

Referring to FIG. 5, a recovery line ring 132 having a loop or hook shape may be formed on a side of the recovery line 131. The recovery line ring 132 may be provided on an end of the recovery line 131 that connects the plurality of neutron absorbers 130, and the neutron absorbers 130 may be easily recovered by using the recovery line ring 132 having a loop or hook shape.

Referring to FIGS. 3 and 4, the storage container 120 may include a body portion 121 in which the neutron absorber 130 is contained and a lid portion 122 detachably coupled to the top of the body portion 121. A coupling portion 123 to which the recovery line ring 132 is coupled may be provided inside the lid portion 122.

The coupling portion 123 may have any of various shapes as long as the recovery line ring 132 may be coupled to the coupling portion 123, and, for example, the coupling portion 123 may have a ring shape. Once the recovery line ring 132 is coupled to the coupling portion 123 of the lid portion 122, the neutron absorber 130 may be easily recovered by separating the lid portion 122 from the body portion 121.

In detail, as shown in FIG. 5, after the neutron absorber 130 is inserted into the guide pipe 110, the neutron absorber 130 is removed from the guide pipe 110 by separating the lid portion 122 from the body portion 121. Accordingly, the neutron absorber 130 may be easily recovered.

According to an embodiment of the present disclosure, in order to recover the sealing member 141 that is melted and dropped, the storage container 120 and the guide pipe 110 may be integrally formed with each other. Referring to FIG. 6, as the storage container 120 and the guide pipe 110 are integrally formed with each other, the guide pipe 110 may be separated from the nuclear fuel assembly 111, and thus the neutron absorber 130 and the melted sealing member 141 inserted into the guide pipe 110 may be simultaneously pulled up.

An elastic body 124 may be provided on a side of the storage container 120 according to an embodiment of the present disclosure. The elastic body 124 may be pressed by the neutron absorber 130 when the outlet 125 of the storage container 120 is closed by the sealing member 140.

The elastic body 124 may generate an elastic restoring force when being pressed and compressed, and may include a spring. However, the elastic body 124 is not limited to the spring, and may use any of elements as long as the elastic body 124 may generate an elastic restoring force when being pressed and compressed.

For example, the elastic body 124 may include the recovery line 131. When the recovery line 131 is folded in a zigzag pattern as shown in FIGS. 3 and 4, the recovery line 131 generates an elastic restoring force when being pressed and compressed. The elastic body 124 may include the recovery line 131 as described above, or may include any of various other elements.

Because the elastic body 124 is pressed when the storage container 120 is closed, an elastic restoring force is generated by the elastic body 124 when the storage container 120 is opened. The neutron absorber 130 may be pushed outward due to the elastic restoring force of the elastic body 124, and may be inserted into the guide pipe 110.

The hot wire 150 according to an embodiment of the present disclosure may be provided inside the nuclear reactor 10, and the hot wire 150 may pass through a side 12 of a container 11 of the nuclear reactor 10 and may extend into the nuclear reactor 10.

Referring to FIG. 1, in order to cause the hot wire 150 to pass through the side 12 of the container 11 of the nuclear reactor 10 and extend into the nuclear reactor 10, a hot wire sealing portion 170 for maintaining a pressure boundary of the nuclear reactor 10 may be provided at the side 12 of the container 11.

The hot wire sealing portion 170 includes a sealing body 171 for sealing the hot wire 150 and a flange 172 for sealing a space between the sealing body 171 and the container 11. When the hot wire sealing portion 170 is used, the pressure boundary inside the nuclear reactor 10 may be maintained and the hot wire 150 may extend from the outside of the nuclear reactor 10 into the nuclear reactor 10.

The nuclear reactor secondary shutdown system using melting seal according to an embodiment of the present disclosure may be modified and used as follows.

The secondary shutdown system of the nuclear reactor using melting seal according to another embodiment of the present disclosure includes a support rod 180, and the neutron absorber 130 is connected to the support rod 180 and moves along with the support rod 180. The secondary shutdown system of the nuclear reactor using melting seal according to another embodiment of the present disclosure may share the same features as those of the above embodiment except that the support rod 180 and the neutron absorber 130 are connected with the sealing member 140 therebetween. Accordingly, a detailed description of the same features as those of the above embodiment will be omitted and the following will focus on a modified embodiment.

Referring to FIGS. 7 through 11, the secondary shutdown system of the nuclear reactor using melting seal according to another embodiment of the present disclosure includes the guide pipe 110, the storage container 120, the sealing member 140, and the hot wire 150. The support rod 180 may be stored in the storage container 120 of the secondary shutdown system of the nuclear reactor using melting seal according to another embodiment of the present disclosure, and the neutron absorber 130 may be connected to the support rod 180 and may be located between the guide pipe 110 and the sealing member 140.

Referring to FIG. 7, the support rod 180 and the neutron absorber 130 may be connected to each other with the sealing member 140 therebetween, and the sealing member 140 is melted by heat supplied by the hot wire 150 to open the storage container 120 and move the support rod 180. A line that connects the support rod 180 and the neutron absorber 130 may pass through the sealing member 140 and may connect the support rod 180 and the neutron absorber 130.

Referring to FIG. 8, when the support rod 180 is moved, the neutron absorber 130 connected to the support rod 180 is also moved to the guide pipe 110. After the neutron absorber 130 is moved to the guide pipe 110, as shown in FIGS. 9 and 10, the neutron absorber 130 may be recovered through the support rod 180 and the recovery line 131.

Also, the storage container 120 and the guide pipe 110 of the secondary shutdown system of the nuclear reactor using melting seal according to another embodiment of the present disclosure may be integrally formed with each other as shown in FIG. 11. As the storage container 120 and the guide pipe 110 are integrally formed with each other, the guide pipe 110 may be separated from the nuclear fuel assembly 111, and thus the neutron absorber 130, the support rod 180, and the melted sealing member 141 inserted into the guide pipe 110 may be simultaneously pulled up.

Referring to FIG. 12, the support rod 180 and the neutron absorber 130 may be formed as one rod. The neutron absorber 130 may be integrally formed with the support rod 180, and the outlet 125 of the storage container 120 may be opened through the sealing member 140, and thus as the support rod 180 moves to the guide pipe 110, the neutron absorber 130 may be inserted into the guide pipe 110.

The secondary shutdown system of the nuclear reactor using melting seal according to an embodiment of the present disclosure has the following effects.

Because the nuclear reactor secondary shutdown system using melting seal according to an embodiment of the present disclosure provides a secondary reactivity control device that does not use boric acid, corrosion of reactor coolant system due to boric acid and corrosion and damage of a pressure boundary due to boric acid leakage may be prevented.

Also, the secondary shutdown system of the nuclear reactor using melting seal according to an embodiment of the present disclosure may simplify equipment by removing complex boric acid injection and recovery equipment. Accordingly, the secondary shutdown system of the nuclear reactor using melting seal according to an embodiment of the present disclosure may minimize interference with other devices or structures inside a nuclear reactor because of a simple structure.

Also, the secondary shutdown system of the nuclear reactor using melting seal according to an embodiment of the present disclosure may contain a neutron absorber through a meltable sealing member and a storage container provided over a guide pipe. The meltable sealing member may be formed of a material that is not melted under a normal operation state and temperature of the nuclear reactor and may maintain a closed state.

Thereafter, when a nuclear reactor accident occurs, the sealing member is melted by a temperature in the nuclear reactor or a heat source supplied by a hot wire and the neutron absorber is injected into the guide pipe. Because the sealing member is melted by the hot wire or the temperature in the nuclear reactor, operational reliability may be improved.

Also, because the secondary shutdown system of the nuclear reactor using melting seal according to an embodiment of the present disclosure includes the storage container located over the guide pipe, and inserts the neutron absorber into the guide pipe due to gravity or inserts the neutron absorber into the guide pipe by using an elastic body provided inside the storage container, operational reliability may be improved.

Because the present disclosure relates to a secondary shutdown system of a nuclear reactor using melting seal, and provides a secondary reactivity control device that does not use boric acid, corrosion of a reactor coolant system due to boric acid and corrosion and damage of a pressure boundary due to boric acid leakage may be prevented.

Also, the present disclosure may simplify equipment by removing complex boric acid injection and recovery equipment. Accordingly, the present disclosure may minimize interference with other devices or structures inside a nuclear reactor because of a simple structure.

Also, the present disclosure may contain a neutron absorber through a meltable sealing member and a storage container provided over a guide pipe, and may melt the sealing member and inject the neutron absorber into the guide pipe when a nuclear reactor accident occurs. Because the present disclosure melts the sealing member by using a hot wire or a temperature in a nuclear reactor, operational reliability may be high.

Also, when a support rod that holds the neutron absorber is provided inside the storage container, the injection of the neutron absorber may be ensured when the nuclear reactor is overturned.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A secondary shutdown system for shutting down a nuclear reactor, the secondary shutdown system comprising:
a guide pipe located inside the nuclear reactor;
a storage container communicating with the guide pipe and storing a neutron absorber therein;
a sealing member provided in the storage container and configured to close an outlet of the storage container so that the neutron absorber stored in the storage container is not moved; and
a hot wire configured to supply heat to the sealing member,
wherein the sealing member is melted by the heat supplied by the hot wire to open the storage container and move the neutron absorber to the guide pipe.

2. The secondary shutdown system of claim 1, wherein the hot wire surrounds an outer surface of the storage container in which the sealing member is located.

3. The secondary shutdown system of claim 2, further comprising a hot wire winding cylinder surrounding the hot wire outside the storage container.

4. The secondary shutdown system of claim 1, wherein the storage container is located over the guide pipe and communicates with the guide pipe,
wherein the neutron absorber is moved to the guide pipe due to gravity when the sealing member is melted and the storage container is opened.

5. The secondary shutdown system of claim 1, wherein the sealing member comprises a material that is melted when a temperature in the nuclear reactor rises to a designated temperature or more,
wherein the sealing member is melted when the temperature in the nuclear reactor rises to the designated temperature or more, to open the storage container and move the neutron absorber to the guide pipe.

6. The secondary shutdown system of claim 1, wherein one or more neutron absorbers having a ball or rod shape are stored in the storage container,
wherein the one or more neutron absorbers are connected to one another through a recovery line.

7. The secondary shutdown system of claim 6, wherein a recovery line ring having a loop or hook shape is formed on a side of the recovery line.

8. The secondary shutdown system of claim 7, wherein the storage container comprises a body portion and a lid portion detachably coupled to the body portion,
wherein a coupling portion to which the recovery line ring is coupled is provided inside the lid portion.

9. The secondary shutdown system of claim 1, wherein an elastic body is provided on a side of the storage container,
wherein the elastic body is pressed by the neutron absorber, when the outlet of the storage container is closed by the sealing member.

10. The secondary shutdown system of claim 1, wherein the hot wire passes through a side of a container of the nuclear reactor and extends into the nuclear reactor,
wherein a heat hot sealing portion for maintaining a pressure boundary inside the nuclear reactor is provided at the side of the container through which the hot wire passes.

11. The secondary shutdown system of claim 1, wherein the storage container and the guide pipe are integrally formed with each other.

12. A secondary shutdown system for shutting down a nuclear reactor, the secondary shutdown system comprising:
a guide pipe located inside the nuclear reactor;
a storage container communicating with the guide pipe and storing a support rod therein;
a sealing member provided in the storage container and configured to close an outlet of the storage container so that the support rod stored in the storage container is not moved;
a hot wire configured to supply heat to the sealing member; and
a neutron absorber connected to the support rod and located between the guide pipe and the sealing member,
wherein the sealing member is melted by the heat supplied by the hot wire to open the storage container, move the support rod, and move the neutron absorber to the guide pipe.

13. The secondary shutdown system of claim 12, wherein an elastic body is provided on a side of the storage container,
wherein the elastic body is pressed by the support rod, when the outlet of the storage container is closed by the sealing member.

14. The secondary shutdown system of claim 12, wherein the storage container and the guide pipe are integrally formed with each other.
